(19) United States
(12) Patent Application Publication
(10) Pub. No.: US 2002/0135202 A1
(43) Pub. Date: Sep. 26, 2002

(54) PROTECTIVE COVER FOR A PICKUP TRUCK TAILGATE

(76) Inventor: Douglas D. Rokahr, Page, NE (US)

Correspondence Address: MCKEE, VOORHEES & SEASE, P.L.C., 801 GRAND AVENUE, SUITE 3200, DES MOINES, IA, 50309-2721, US

(21) Appl. No.: 09/812,744

(22) Filed: Mar. 20, 2001

(51) Int. Cl. B62D 33/03

(52) U.S. Cl. 296/136; 296/57.1

(57) ABSTRACT

A protective cover is disclosed which is positioned adjacent the rear side of a pickup truck tailgate to protect the same from rock chips, etc. The lower end of the cover is removably attached to the lower end of the tailgate. The upper end of the cover is removably attached to the upper end of the tailgate.

### BACKGROUND OF THE INVENTION

1. Field of the Invention

This invention relates to a protective cover for a pickup truck tailgate and more particularly to a protective cover which protects the rear side of a pickup truck tailgate.

2. Description of the Related Art

Many types of protective covers or “bras” have been previously provided for protecting the front ends of cars and trucks from rock chips, etc. Further, protective covers or shields have also been provided for the protection of the cargo side of a pickup truck tailgate, since the cargo side of the tailgate is exposed to the materials being transported in the truck box such as rocks, lumber, etc. Additionally, protective covers have also been provided to protect the rearward side of the tailgate, since rocks sometimes are thrown from a passing vehicle towards a trailer or the like which is being pulled by the pickup truck with the rocks bounding forwardly from the trailer onto the rear side of the tailgate. Tailgate protective covers, which protect the rear surface of a pickup truck tailgate, are disclosed in Des. Pat. Nos. 433,661 and 323,639. Although the covers of the '661 and '639 patents would appear to protect the tailgates upon which they are mounted, it is believed that those covers are less than convenient to install and will perhaps become inadvertently detached during use.

### SUMMARY OF THE INVENTION

A protective cover for a pickup truck tailgate is disclosed which is designed to be placed adjacent the rear side of the tailgate to prevent flying rocks from chipping the finish of the tailgate. The cover of this invention comprises a generally rectangular, flexible plastic and/or fabric cover member having a rear side, a front side, an upper end, a lower end, and opposite side edges. An elongated, J-shaped channel member is secured to the lower end of the cover member and extends between the side edges thereof. An elongated strip of the hooked portion of a hook-and-loop fastener is secured to the upper front end of the cover member and which extends between the side edges of the cover member. The lower end of the protective cover is secured to the tailgate by attaching the J-shaped channel member to the lower end of the tailgate. The upper end of the protective cover is secured to the tailgate by securing the strip of the hooked portion of the hook-and-loop fastener to a strip of the looped portion of the hook-and-loop fastener which is secured to the upper forward end of the tailgate.

It is therefore a principal object of the invention to provide a protective cover for the rearward side of a pickup truck tailgate.

A further object of the invention is to provide a protective cover for the rearward side of a pickup truck tailgate which is conveniently attached to the tailgate.

A further object of the invention is to provide a protective cover for the rearward side of a pickup truck tailgate which will not become detached during use.

A further object of the invention is to provide a protective cover for the rearward side of a pickup truck tailgate which economical of manufacture, durable in use and refined in appearance.

These and other objects will be apparent to those skilled in the art.

### BRIEF DESCRIPTION OF THE DRAWINGS

FIG. 1 is a rear perspective view of the protective cover of this invention mounted on a pickup truck tailgate;

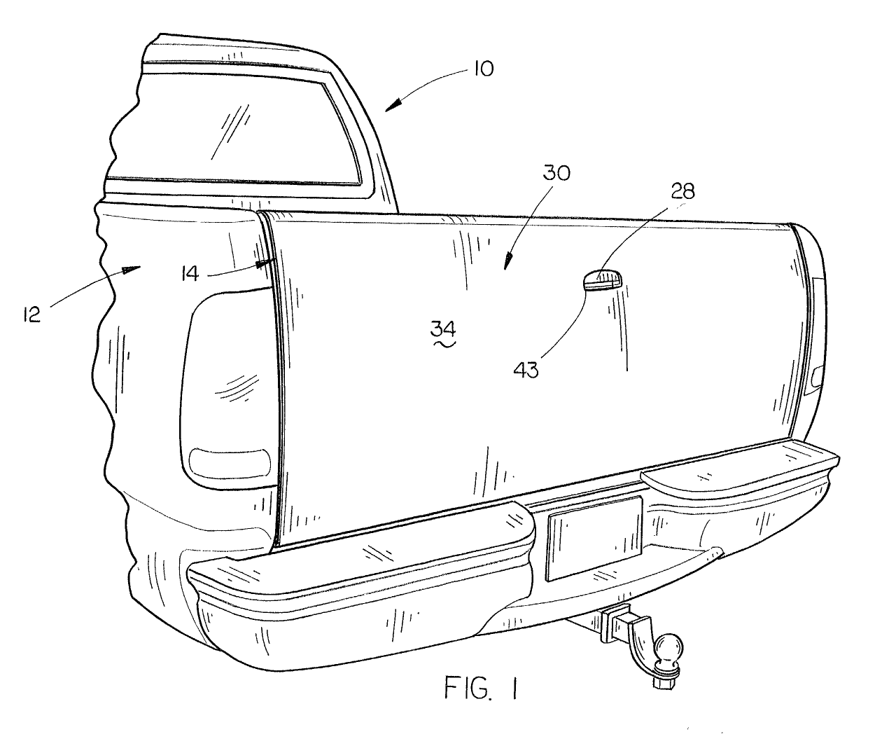

FIG. 2 is a front perspective view of the protective cover;

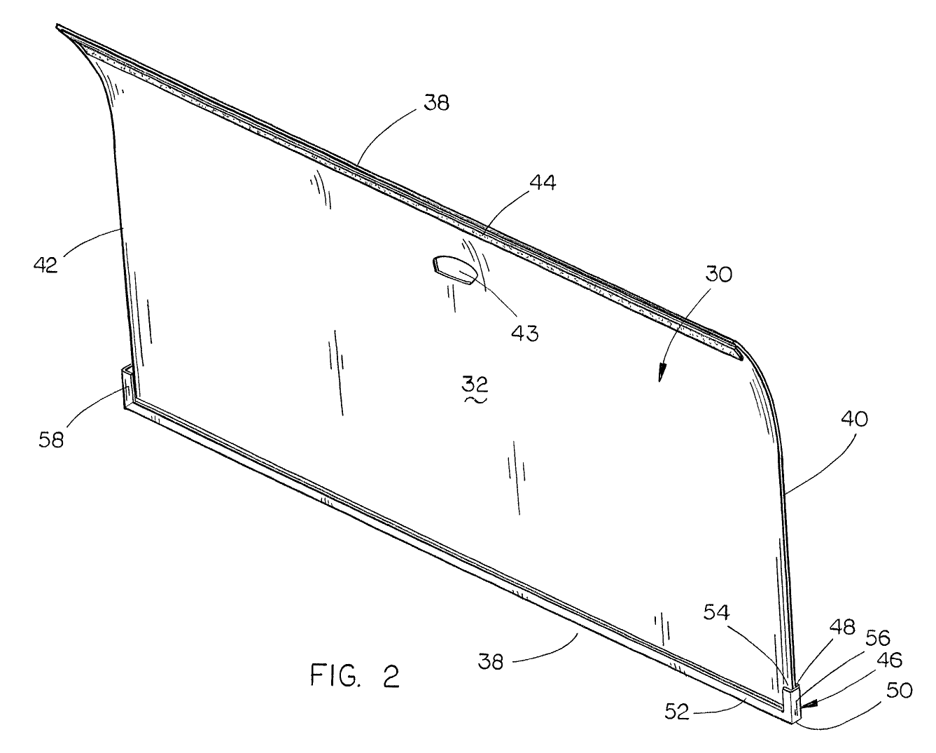

FIG. 3 is a front perspective view of the tailgate and the cover; and

FIG. 4 is a sectional view illustrating the protective cover mounted on the tailgate.

### DESCRIPTION OF THE PREFERRED EMBODIMENT

The numeral 10 refers to a conventional pickup truck having a truck bed 12 and a tailgate 14. Tailgate 14 includes a cargo side 16, rear side 18, upper end 20, lower end 22, and opposite side edges 24 and 26. Tailgate 14 is provided with a conventional rearwardly presented handle 28 mounted thereon for opening the tailgate 14. Normally, most tailgates have a lip or flange 29 at the lower end thereof which extends downwardly from the lower rearward end thereof.

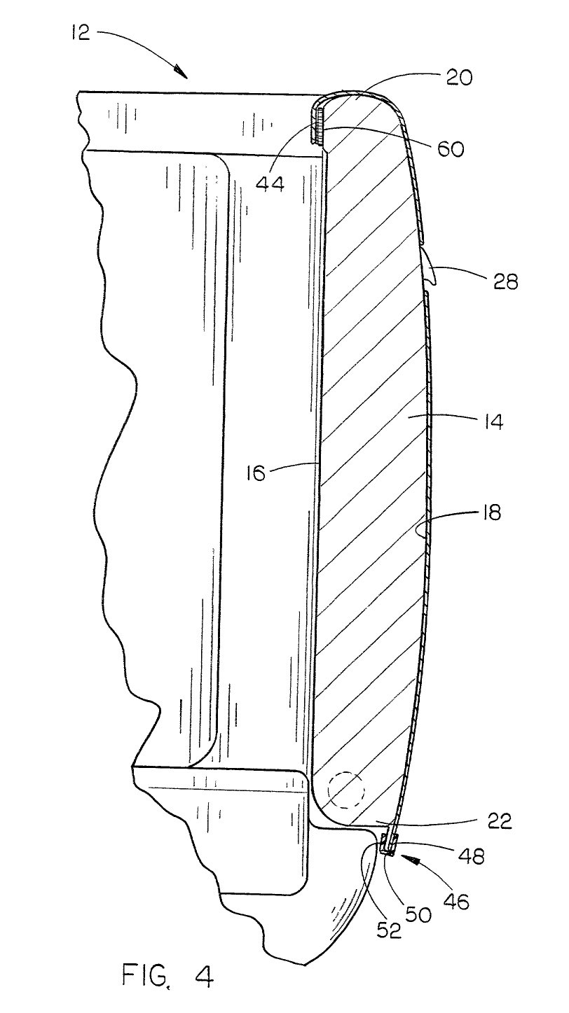

The protective cover of this invention is referred to by the reference numeral 30 and is preferably constructed of a flexible plastic material or a flexible fabric material such as used on protective covers fitted to the front of vehicles to protect the same. Cover 30 includes an interior or front surface 32, exterior or rear surface 34, an upper end 36, a lower end 38, and opposite side edges 40 and 42. Cover 30 is provided with an elongated opening 43 formed therein adapted to register with the tailgate handle 28 when cover 30 is mounted on the tailgate 14. An elongated strip 44 of the hooked portion of a hook-and-loop fastener material such as Velcro™ or the like is secured to the front surface 32 of cover 30 at the upper interior end thereof. In the preferred embodiment, an elongated J-shaped channel member 46, comprised of plastic or the like, is secured to the lower end of the cover 30. For purposes of description, channel member 46 will be described as including leg portion 48, base portion 50 which may either be curved or flat, and leg portion 52. Leg portion 48 is secured to the lower end of the cover 30 by stitching, adhesive, etc., as seen in FIG. 4. When secured to the cover 30, as seen in FIG. 4, the leg portion 52 is spaced forwardly of cover 30 to provide a space 54 between leg portion 52 and cover 30. Space 54 is provided so as to be able to receive the lip 29 of the tailgate 14 when the cover is secured to the tailgate 14. As seen, channel member 46 has outer end portions 56 and 58, respectively, which receive the lower ends of side edges 40 and 42, respectively, of cover 30 for strengthening or reinforcing purposes. The upper inner end of tailgate 14 has an elongated strip 60 of the looped portion of a hook-and-loop fastener material such as Velcro or the like secured thereto.

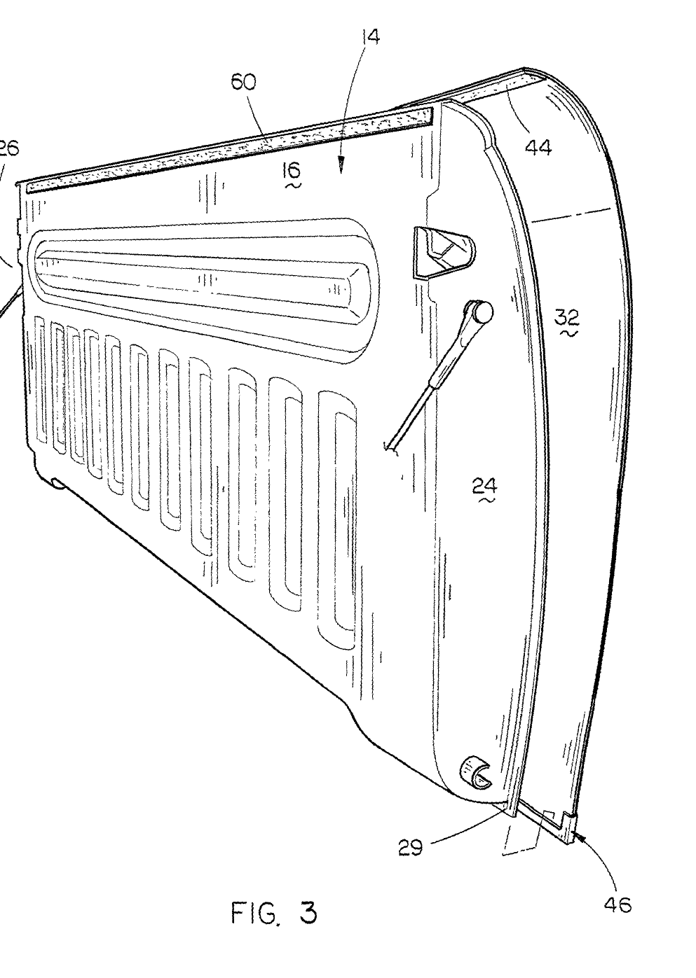

When it is desired to mount the protective cover 30 on the tailgate 14 to protect the rearward side thereof, the cover 30 is positioned adjacent the rear side of tailgate 14 with the front surface 32 of the cover 30 being adjacent the rear side of tailgate 14, as seen in FIG. 3. The J-shaped channel member 46 is then secured to the lip 29 at the lower end of tailgate 14 so that lip 29 is received in space 54. The upper end 36 of cover 30 is then drawn over the upper end 20 of tailgate 14 so that strip 60 may be secured to strip 44 thereby securely mounting the cover 30 on tailgate 14 to protect the rearward surface thereof. When the cover 30 is positioned on the tailgate 14, the opening 43 of cover 30 registers with the tailgate handle 28 to provide convenient access thereto.

The fact that the upper end 36 folds over the upper end 20 of tailgate 14, as seen in FIG. 4, reduces the possibility that wind could inadvertently blow the cover 30 from the tailgate 14. Although the J-shaped channel member 46 is the preferred method of securing the lower end of the cover 30 to the lower end of the tailgate 14, a strip of the hooked portion of a hook-and-loop material could be secured to the lower end of tailgate 14 and a strip of the looped portion of a hook-and-loop material could be secured to the lower front side of cover 30 for engagement with the hooked strip on the lower end of tailgate 14. Further, in some cases, the opening 43 may be omitted if the tailgate does not have a tailgate handle at its rear side.

Although it is preferred that strips 44 and 60 extend continuously across the widths of cover 30 and tailgate 14, spaced-apart strips 44 and spaced-apart strips 60 could be utilized. Further, while strip 44 has been described as being hooked and strip 60 has been described as being looped, strip 44 could be looped and strip 60 could be hooked.

Additionally, although it is preferred that the J-shaped channel member 46 extend continuously across the lower end of cover 30, a plurality of spaced-apart J-shaped channel members could be secured to the lower end of cover 30. However, it is believed that the use of a continuous J-shaped channel member improves the appearance of the cover and lessens the likelihood that the lower end of the cover will inadvertently become disconnected from the tailgate. Further, while the J-shape of the channel member 46 is the preferred shape, it is possible that a U-shaped channel member could be substituted therefore. It is believed that the J-shape enhances the attachment of the channel member to the cover 30.

Thus it can be seen that the invention accomplishes at least all of its stated objectives.

I claim:

1. A protective cover for a pickup truck tailgate which includes an upper end, a lower end, a cargo side, a rear side, opposite side edges, and at least one strip of looped material secured to the upper end of the tailgate, comprising:
a flexible, generally rectangular cover member having an upper end, a lower end, a front side, a rear side, and opposite side edges;
said cover member being positioned adjacent the rear side of the tailgate;
said cover member having a connector at its lower end for removable connection to the lower end of the tailgate;
at least one strip of hooked material secured to the upper front side of said cover for removable connection to the strip of looped material on the upper end of the tailgate.

2. The protective cover of claim 1 wherein said connector comprises a J-shaped channel member.

3. The protective cover of claim 1 wherein said connector comprises a channel member.

4. The protective cover of claim 2 wherein said channel member extends the entire width of said cover member.

5. The protective cover of claim 3 wherein said channel member extends the entire width of said cover member.

6. The protective cover of claim 4 wherein said channel member has opposite end portions which embrace the lower ends of said side edges of said cover member.

7. The protective cover of claim 5 wherein said channel member has opposite end portions which embrace the lower ends of said side edges of said cover member.

8. The protective cover of claim 1 wherein said cover member extends upwardly and forwardly over the upper end of the tailgate for attachment to the strip of looped material on the upper end of the tailgate.
